(19) United States
(12) Patent Application Publication
(10) Pub. No.: US 2014/0102384 A1
(43) Pub. Date: Apr. 17, 2014

(54) SENSOR ATTACHMENT METHOD INCORPORATING LOCKING RETENTION FEATURE THAT WILL ONLY ENGAGE WHEN THE DEVICE IS PROPERLY INSTALLED

(71) Applicant: Amphenol Corporation, Wallingford, CT (US)

(72) Inventors: Brian Allen Engle, Armada, MI (US); David John Geer, Johnsonburg, PA (US); Brian Scott Vanish, Madera, PA (US); Karen Marie Pistner, Dubois, PA (US); George Szabo, Ortonville, MI (US)

(73) Assignee: Amphenol Corporation, Wallingford, CT (US)

(21) Appl. No.: 13/652,764

(22) Filed: Oct. 16, 2012

(51) Int. Cl. G01D 11/30

(52) U.S. Cl. CPC G01D 11/30
USPC 123/41.01; 73/866.5; 29/428

(57) ABSTRACT

A sensor assembly, which may be part of an engine cooling system, senses a condition within an enclosed volume. The sensor assembly includes a mounting structure projecting from a wall of the enclosed volume. The mounting structure includes an opening extending from an exterior of the mounting structure towards the wall and at least one channel extending along an exterior of the mounting structure. The sensor assembly further includes a connector having a sensing portion for sensing the condition within the enclosed volume. A seal seals the enclosed volume at the extension of the connector through the opening. A retaining device has at least one attachment structure that is insertable into the at least one channel. The attachment structure engages the connector such that the connector is non-removable from the mounting structure. An associated method provides the sensor assembly.

### BACKGROUND OF THE INVENTION

1. Field of the Invention

The present invention relates generally to sensor assemblies and, more particularly, to attaching a sensor assembly to cooling system of an engine.

2. Discussion of the Prior Art

Sensor assemblies are common in the automotive industry. Some sensor assemblies are used, for example, to monitor temperatures within a cooling system of an engine. In general, a cooling system sensor assembly is attached to a wall of the cooling system, with a portion of the sensor assembly (e.g., thermistor, etc.) extending into a cooling fluid to measure the cooling fluid temperature. To properly attach the sensor assembly to the wall of the cooling system, specialized tools have been required. In particular, manual, pneumatic, and/or electrically-driven wrenches utilizing specific thread engagement designs have been used for attachment of the sensor assemblies. These tools can be costly and may result in slow attachment times. Further, these tools may difficult to use in a confined environment associated with a vehicle engine.

Accordingly, it would be beneficial to provide a sensor assembly that allows for manual attachment of the sensor assembly to a wall of the cooling system. Further, it would be beneficial to provide ease of attachment and/or promote proper attachment of a sensor assembly.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a sensor assembly for sensing a condition within an enclosed volume. The sensor assembly includes a mounting structure projecting from a wall bounding the enclosed volume. The mounting structure includes an opening extending from an exterior of the mounting structure through the wall into the enclosed volume. The mounting structure includes at least one channel extending along an exterior of the mounting structure. The sensor assembly includes a connector that includes a sensing portion that senses the condition within the enclosed volume. The connector is engagable with the mounting structure to extend the connector through the opening of the mounting structure and position the sensing portion at least partially within the enclosed volume. The sensor assembly includes a seal engagable with the mounting structure and sealing the enclosed volume at the extension of the connector through the opening. The sensor assembly includes a retaining device that includes at least one attachment structure. The at least one attachment structure is insertable into the at least one channel to engage the connector and hold the connector engaged to the mounting structure extended through the opening.

In accordance with another aspect, the present invention provides an engine with a cooling system. The engine cooling system including an enclosed volume having cooling fluid therein. The cooling system includes a wall bounding the enclosed volume. The engine cooling system including a sensor assembly for sensing a condition of the cooling fluid within the enclosed volume. The sensor assembly includes a mounting structure projecting from a wall bounding the enclosed volume. The mounting structure includes an opening extending from an exterior of the mounting structure through the wall into the enclosed volume. The mounting structure includes at least one channel extending along an exterior of the mounting structure. The sensor assembly includes a connector that includes a sensing portion that senses the condition within the enclosed volume. The connector is engagable with the mounting structure to extend the connector through the opening of the mounting structure and position the sensing portion at least partially within the enclosed volume. The sensor assembly includes a seal engagable with the mounting structure and sealing the enclosed volume at the extension of the connector through the opening. The sensor assembly includes a retaining device that includes at least one attachment structure. The at least one attachment structure is insertable into the at least one channel to engage the connector and hold the connector engaged to the mounting structure extended through the opening.

In accordance with another aspect, the present invention provides a method of providing a sensor assembly for sensing a condition within an enclosed volume. The method including providing a mounting structure projecting from a wall bounding the enclosed volume. The mounting structure includes an opening extending from an exterior of the mounting structure through the wall into the enclosed volume. The mounting structure includes at least one channel extending along an exterior of the mounting structure. The method includes engaging a connector, which includes a sensing portion that senses the condition within the enclosed volume, to the mounting structure and extending the connector through the opening of the mounting structure and positioning the sensing portion at least partially within the enclosed volume. The method includes engaging a seal with the mounting structure and sealing the enclosed volume at the extension of the connector through the opening. The method includes inserting at least one attachment structure of a retaining device into the at least one channel to engage the connector and hold the connector engaged to the mounting structure extended through the opening.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a highly schematic representation of an example engine including an example cooling system having an enclosed volume;

FIG. 2 is a perspective view of an example sensor assembly in attachment with a wall bounding the enclosed volume in accordance with an aspect of the present invention;

FIG. 3 is a perspective view of an example connector of the sensor assembly of FIG. 2;

FIG. 4 is a sectional view along lines 4-4 of FIG. 2 depicting the example sensor assembly in attachment with the wall of the enclosed volume, and shows the example connector engaged to an example mounting structure of the sensor assembly and held by an example retaining device of the assembly;

FIG. 5 is a perspective view of the sensor assembly in which the example retaining device is in the process of inserting to the example mounting structure;

FIG. 6 is a perspective view of the example retaining device; and

FIG. 7 is a perspective view similar to FIG. 5 but with the retaining device being fully inserted to the mounting structure.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

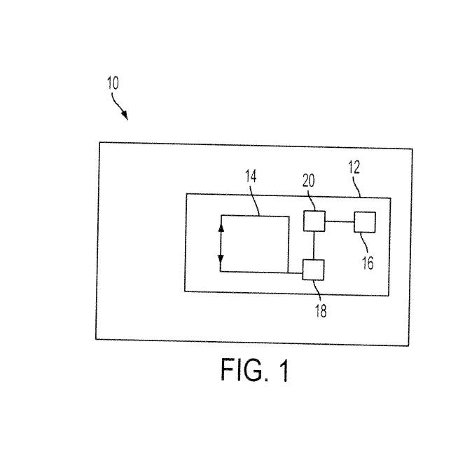

FIG. 1 is a highly schematic representation of an example engine 10 according to one aspect of the invention. It is to be appreciated that the engine 10 can be of any of a number of constructions (e.g., internal combustion, turbine, etc.). In at least one example, the engine 10 can convert energy into mechanical motion. Though not shown in the example, the engine 10 can include parts that are commonly present (e.g., pistons, valves, spark plugs, crankshafts, etc.). The engine 10 may be used in any number of applications that generally utilizes engines, including vehicles (e.g., automobiles, motorcycles, locomotives, other land-based vehicles, etc.), watercrafts (e.g., ships, boats, etc.), aircrafts, spacecraft, tools, etc. As is generally known, the engine 10 will generate heat and thus could reach relatively high temperatures during operation unless the engine is cooled.

In accordance with an aspect of the invention, the engine 10 includes a cooling system 12 having an enclosed volume 18 that is highly schematically depicted. The enclosed volume 18 contains a fluid, often referred to as a cooling fluid (e.g., air, gaseous fluids, liquid coolants commonly termed antifreeze, etc.), for cooling the engine 10 or at least component/portions of the engine. The enclosed volume 18 includes any number of structures, such as pipes, tubes, conduits, tanks, receptacles, containers, etc. By being enclosed, the enclosed volume 18 can limit an undesired release of the cooling fluids within the cooling system 12 and engine 10. As can be appreciated the enclosed volume 18 of the cooling system 12 includes one or more flow paths 14 along which the cooling fluid travels through the engine 10 to cool the engine 10 and/or engine components/portions thereof. The flow path(s) 14 may be provided as loops for recirculation.

As will be appreciated by the person of skill, the engine 10 includes the cooling system 12 for the purpose of controlling and/or reducing the heat within the engine 10. It is to be appreciated that the cooling system 12 is generically/schematically depicted in FIG. 1, as the cooling system 12 includes any number of structures and constructions. For example, the cooling system 12 can include radiators, fans, cooling fluids tubes, conduits, pumps, valves and the like.

The cooling system 12 further includes a controller 16. The controller 16 is also highly generically/schematically depicted in FIG. 1. The controller 16 can include any number of different configurations. In one example, the controller 16 is operatively attached to at least some of the components within the cooling system 12. The controller 16 can send and receive information (e.g., data, control instructions, etc.) to/from components within the cooling system 12. The controller 16 can include circuits, processors, running programs, memories, computers, power supplies, or the like. In further examples, the controller 16 includes a user interface, display, and/or other devices for allowing a user to control aspects of the cooling system 12. In general, the controller 16 can utilize information received from some cooling system components to control other cooling system components. For example, the controller 16 receives information from sensors within the cooling system 12. Also for example, the controller 16 can control operation of pumps, valves, fans, etc. that may be present in the cooling system 12. It is to be appreciated that because heat/temperature is the focus of the cooling system, information about heat/temperature, and the flow of coolant to address such heat/temperature, is used by the controller 16 and the controlled operation of pumps, valves, fans, etc. of the cooling system is for the temperature control and the flow of coolant to provide such temperature control.

To provide accurate monitoring of the cooling fluid, a sensor assembly 20 in accordance with an aspect of the present invention is provided for sensing a condition (e.g., temperature, level, etc.) of the cooling fluid. It is to be appreciated that the sensor assembly is highly schematized in FIG. 1. But, it is to be appreciated that one aspect of the present invention is that specialized tools and/or a time consuming attachment method may not be needed for attaching the sensor assembly 20 to the enclosed volume 18. Such provides for attachment of the sensor assembly 20 that is easy, efficient and/or providing a high connection reliability.

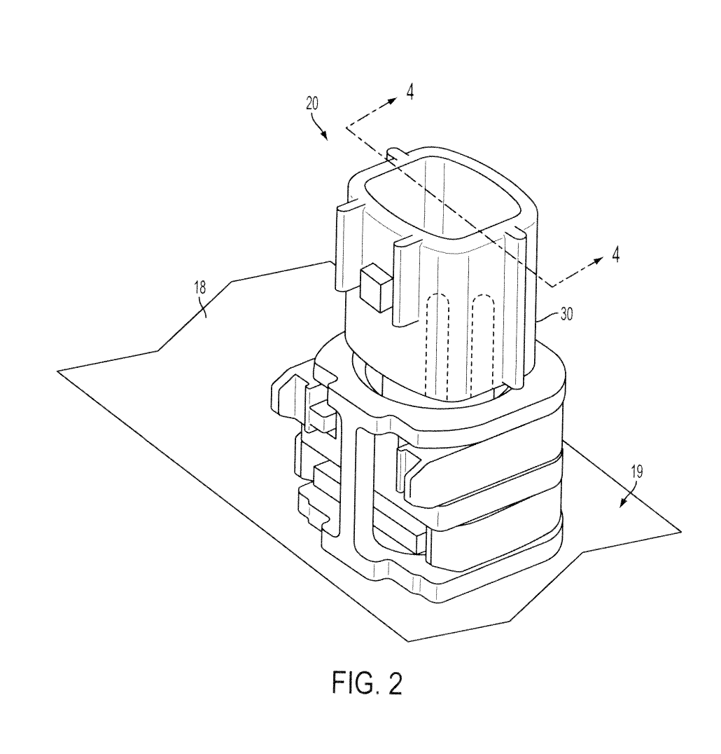

Turning to the sensor assembly 20 of the cooling system 12. the sensor assembly 20 is in operative association with at least some of the components of the cooling system 12. In one example, the sensor assembly 20 is operatively attached to the controller 16. This operative attachment is generically/schematically depicted as a line in FIG. 1. It is to be appreciated that the line between the sensor assembly 20 and controller 16 can include any number of communication means, such as electrical wires, wireless communication, or the like. The sensor assembly 20 can send and/or receive information from the controller 16. For example, the sensor assembly 20 can sense/detect a condition (e.g., temperature, fluid quality, etc.) and transmit information related to this condition to the controller 16. The sensor assembly 20 can also be operatively attached to the enclosed volume 18. The operative attachment of the sensor assembly 20 and the enclosed volume 18 is also generically/schematically depicted in FIG. 1, but is more clearly shown in FIG. 2.

Turning now to FIG. 2, the sensor assembly 20 is attached to a wall 19 that bounds the enclosed volume 18. It is to be appreciated that the wall 19 can be at any part (e.g., pipes, tubes, conduits, or the like) of the enclosed volume 18. In general, the sensor assembly 20 has at least a portion that projects through the wall 19 and into an interior of the enclosed volume 18 to be in direct engagement within the interior of the enclosed volume and the cooling fluid therein. It is to be appreciated that the enclosed volume 18 and wall 19 are somewhat generically/schematically depicted in FIG. 2 for illustrative purposes. Indeed, only a portion of the surface of the enclosed volume 18 and wall 19 are shown, so as to more clearly depict the relationship of the sensor assembly 20 with the enclosed volume 18. The sensor assembly 20 senses/monitors the contents (e.g., the cooling fluid, etc.) of the enclosed volume 18, and provides information to the controller 16.

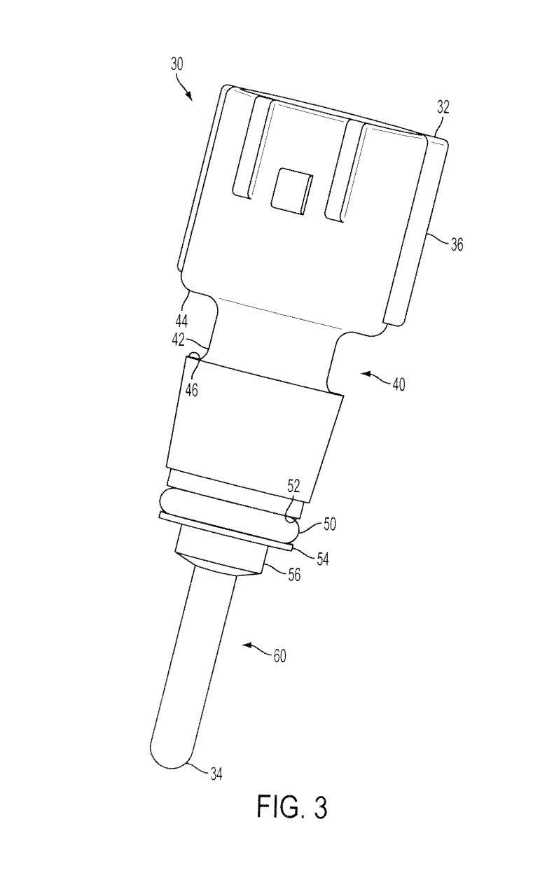

Referring now to both FIGS. 2 and 3, the sensor assembly 20 includes a connector 30. The connector is an elongate body that includes one or more structures/components sense a condition in the cooling fluid. The connector 30 extends between a first end 32 (see FIG. 3) and an opposing second end 34. The connector 30 can be longer or shorter in further examples, and could include a variety of constructions.

Turning to the first end 32, the connector 30 includes a mating portion 36. The mating portion 36 can mate with a separate electrical device/connection lead (not shown) to transfer information from/to the connector 30. The mating portion 36 may include terminals, pins, plugs, sockets, or the like. Indeed, the mating portion 36 can include various types of electrical connectors for joining the connector 30 to the separate electrical device connection lead. The connection between the mating portion 36 and the separate electrical device can be permanent or temporary, such as being readily attachable or detachable. In general, the mating portion 36 will allow for information to be transferred to/from the connector 30 ultimately to the controller 16.

Moving away from the first end 32, the connector 30 further includes an attachment section 40. The attachment section 40 is positioned adjacent the mating portion 36 closer to the second end 34. The attachment section 40 is not limited to such a location, and in further examples, could be positioned closer to the first end 32 or closer to the second end 34. The attachment section 40 can assist in attaching the connector 30 with respect to the enclosed volume 18.

The attachment section 40 can include a number of structures that allow for attaching/securing of the connector 30 with respect to the enclosed volume 18. In one example, the attachment section 40 includes a groove 42. The groove 42 extends circumferentially around the connector 30. The groove 42 is a radially inwardly projecting channel that extends towards a center of the connector 30. The groove 42 is not limited to the dimensions shown in FIG. 3, and in other examples, could extend for a larger or smaller distance towards the center of the connector 30. Likewise, the groove 42 could extend a longer or shorter axial length along the connector 30.

The groove 42 is bound on at least one side by one or more shoulders. In the shown example, the groove 42 is bound on opposing sides by a first shoulder 44 and a second shoulder 46. The first shoulder 44 is positioned at an end of the groove 42 that is closer to the first end 32 while the second shoulder 46 is positioned at an opposing end of the groove 42 that is closer to the second end 34. The first shoulder 44 and second shoulder 46 have a larger cross-sectional size (e.g., diameter in the shown example) than the groove 42, such that the connector 30 has a generally non-constant cross-sectional size (e.g., diameter) along the attachment section 40. The first shoulder 44 and second shoulder 46 may or may not have identical cross-sectional sizes. In the shown example, the first shoulder 44 has a larger cross-sectional size than the second shoulder 46, though in other examples, the first shoulder 44 and second shoulder 46 could have approximately the same size, or the first shoulder 44 could have a smaller cross-sectional size than the second shoulder 46.

Moving further away from the first end 32, the connector 30 further includes a portion that receives/retains a seal 50. The seal 50 has a shape that generally matches a shape of the connector 30. For example, in FIG. 3, the seal 50 has a circular shape and extends circumferentially around the connector 30. Of course, the seal 50 is not limited to such a shape, and in further examples, could include other shapes (e.g., square, rectangular, oval, etc.). The seal 50 can be formed of a number of materials that can provide a seal, such as elastomer-like materials (e.g., rubber), or the like. In other examples, the seal 50 can be filled with a material, such as a liquid material. The seal 50 is resiliently deformable with respect to the connector 30, which is relatively rigid. The deformation of the seal 50 may include relative axial deformation movement and/or relative radial deformation movement. As such, the seal 50 can deform in response to axial and/or radial forces (e.g., compression force).

The seal 50 is positioned adjacent a third shoulder 52. In the shown example, the third shoulder 52 is positioned next to a side of the seal 50 that is closest to the first end 32. The third shoulder 52 is rigid (i.e., non-movable), such that the seal 50 contacts the third shoulder 52 and moves (e.g., compresses, etc.) with respect to the third shoulder 52. The third shoulder 52 has a cross-sectional size (e.g., diameter in the shown example) that is slightly smaller than a cross-sectional size of the seal 50. For example, in FIG. 3, the third shoulder 52 has a smaller diameter than an outer surface of the seal 50, such that the outer surface of the seal 50 protrudes a larger distance outwardly (i.e., away from a center axis of the connector 30) than the third shoulder 52. In further examples, however, the third shoulder 52 and seal 50 are not limited to the shown sizes, as a number of dimensions are envisioned.

The connector 30 further includes a seal retaining structure 54. The seal retaining structure 54 is positioned adjacent the seal 50 opposite the third shoulder 52. As shown, the seal 50 is positioned between the third shoulder 52 on one side and the seal retaining structure 54 on an opposing second side. The seal retaining structure 54 can have a size and shape that generally matches a size and shape of the seal 50. For example, the seal retaining structure 54 is generally circular in the shown example, though in other examples, the seal retaining structure 54 could have other shapes, such as square, rectangular, oval shapes, etc. The seal retaining structure 54 is movable with respect to the connector 30. In particular, the seal retaining structure 54 is axially movable with respect to the connector 30. As such, movement of the seal retaining structure 54 towards the first end 32 can cause compression of the seal 50.

The connector 30 includes a connector shaft 56. The connector shaft 56 extends axially along at least a portion of the length of the connector 30. In one example, the connector shaft 56 extends from the third shoulder 52 towards the second end 34. The connector shaft 56 can have any number of sizes and shapes, though in the shown example, the connector shaft 56 has a generally cylindrical shape with a circular cross-section. The connector shaft 56 can extend through each of the seal 50 and the seal retaining structure 54. In one example, the connector shaft 56 extends through openings formed in the center of each of the seal 50 and seal retaining structure 54. As such, the connector shaft 56 limits radial movement of the seal 50 and seal retaining structure 54 and reduces the likelihood of the seal 50 and seal retaining structure 54 from becoming off-centered from the connector 30. In further examples, the connector shaft 56 could have a larger or smaller cross-sectional size (e.g., diameter) to accommodate for larger or smaller openings in the seal 50 and/or the seal retaining structure 54.

Moving further away from the first end 32 and towards the second end 34, the connector 30 includes a sensing portion 60 for sensing a condition within the enclosed volume 18. The sensing portion 60 is an elongated probe-like portion that extends from the connector shaft 56 and defines the second end 34 of the connector 30. The sensing portion 60 has a generally cylindrical shape, though in further examples, the sensing portion 60 could be longer or shorter than as shown, and/or could have other shapes.

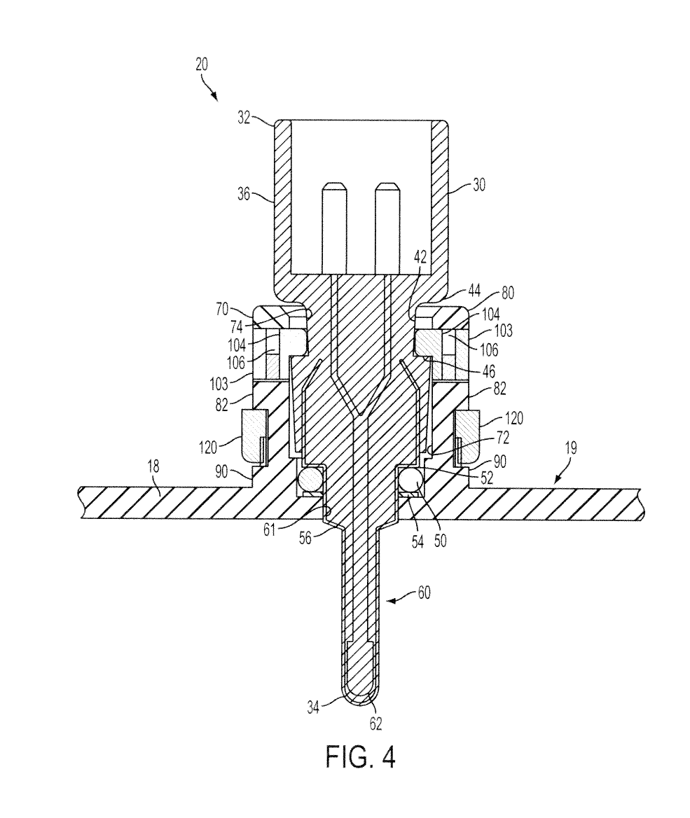

Turning now to FIG. 4, a sectional view along line 4-4 of FIG. 2 is shown. The sensing portion 60 can extend through a wall opening 61 in the wall 19. In particular, the sensing portion 60 extends through the wall opening 61 and into an interior portion of the enclosed volume 18. In the shown example, the wall opening 61 is large enough to accommodate the sensing portion 60 and the connector shaft 56. In further examples, however, the wall opening 61 could be smaller, such as to accommodate the sensing portion 60 but not the connector shaft 56. In the shown example, the wall opening 61 is sized to substantially match a shape of the connector shaft 56, such that a gap size between the connector shaft 56 and edges of the wall opening 61 is reduced.

The sensing portion 60 includes a sensing element 62. The sensing element 62 is somewhat generically/schematically depicted, as it is to be appreciated that the sensing element 62 can include a wide variety of different structures. The sensing element 62 will sense a condition within the enclosed volume 18. For example, the sensing element 62 of the sensing portion 60 will sense the condition (e.g., temperature, level, etc.) of the cooling fluid within the enclosed volume 18. In one example, the sensing element 62 includes a thermistor for measuring temperature of the cooling fluid. In other examples, the sensing element 62 includes a negative temperature coefficient (NTC) thermistor, a resistance temperature detector (RTD), a thermocouple, a MEMS-based pressure sensor, or the like. The sensing element 62 can sense any number of conditions within the enclosed volume 18, including temperature, pressure, or the like. Further, the sensing element 62 can transmit information related to the conditions from the connector 30 to the controller 16. To again touch upon the mating portion 36 and the ability to mate with a separate electrical device/connection lead (not shown) to transmit information to the connector 30, FIG. 4 schematically shows some example terminals/pins within the mating portion that are schematically shown to be connected to the sensing element 62.

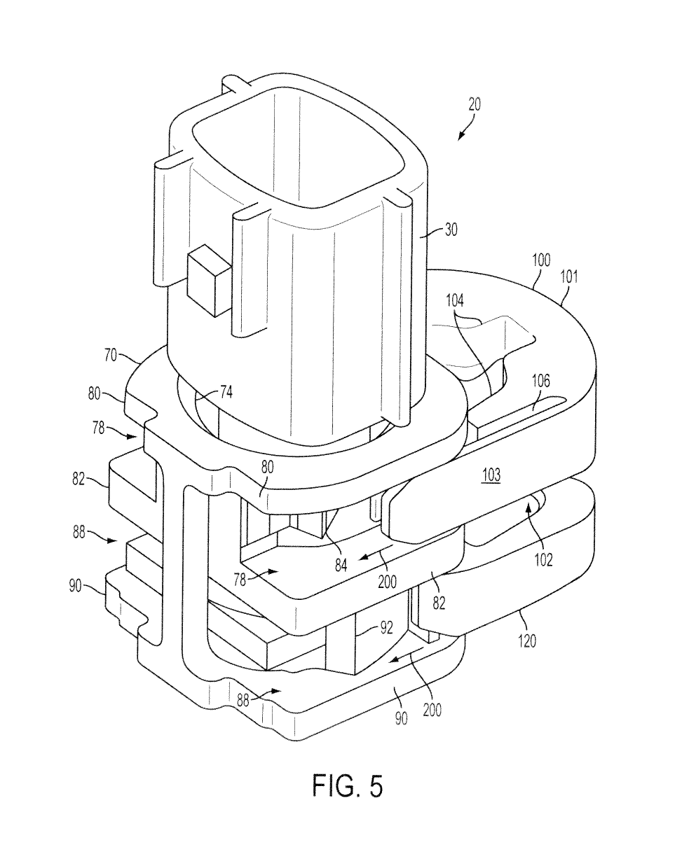

With continued reference to FIG. 4 and now with reference also to FIG. 5, the sensor assembly 20 further includes a mounting structure 70. The mounting structure 70 projects outwardly from the wall 19 that bounds the enclosed volume 18. In one example, the mounting structure 70 projects in a direction away from the interior of the enclosed volume 18. The mounting structure 70 can be integrally formed or joined with the enclosed volume 18 (as shown), such as by welding or the like. In other examples, the mounting structure 70 is separately attached to the enclosed volume 18, such as with mechanical fasteners, adhesives, etc.

The mounting structure 70 defines a generally cylindrically shaped housing having a substantially hollow bore 72. The hollow bore 72 extends from an opening 74 at an end of the mounting structure 70 towards the wall 19. The hollow bore 72 and opening 74 are sized and shaped to receive the connector 30 therein. In particular, the hollow bore 72 and opening 74 can have a slightly larger cross-sectional size (e.g., diameter in shown example) than the cross-sectional size of the connector 30. As such, the connector 30 can be selectively inserted and removed from the hollow bore 72. In the illustration of FIG. 4, the connector 30 is in a fully inserted position within the mounting structure 70. However, it is to be appreciated that in view of the characteristics of the hollow bore 72 and opening 74, the connector 30 could be selectively removed.

Turning to focus now upon FIG. 5, the enclosed volume 18 is omitted from FIG. 5 for ease of illustrative purposes. However, in operation, the mounting structure 70 will be in association with (e.g., attached to) the wall 19 of the enclosed volume 18 as is to be understood from at least FIGS. 2 and 4.

The mounting structure 70 includes at least one channel extending along an outer or exterior surface of the mounting structure 70. The at least one channel includes a pair of first channels 78. The first channels 78 are positioned in proximity to the opening 74. The first channels 78 are disposed on opposing sides of the mounting structure 70 and each define a channel, groove, or elongated opening extending along the exterior of the mounting structure 70. The first channels 78 are each bound by a first mounting shoulder 80 on an above side and a second mounting shoulder 82 on a below side. In particular, the first channels 78 each extend between the first mounting shoulder 80 and second mounting shoulder 82. The first channels 78 each define an opening or passageway through the mounting structure 70 from the exterior to an interior of the mounting structure.

The first channels 78 each include one or more projections disposed within the first channels 78. In one example, the first channels 78 each include a first projection 84. The first projection 84 is positioned within the first channels 78 and extends from the first mounting shoulder 80 to the second mounting shoulder 82. The first projection 84 defines an outcropping, protrusion, or the like within the first channels 78. In one example, the first projection 84 has a ramped shape. It is to be appreciated that only one of the first projections 84 is shown in FIG. 5, since the other first projection 84 is obstructed from view. However, it is understood that the first projections 84 can be substantially identical in structure and location in each of the first channels 78.

The at least one channel of the mounting structure 70 further includes a pair of second channels 88. The second channels 88 are positioned in proximity to the wall 19 of the enclosed volume 18. The second channels 88 are disposed on opposing sides of the mounting structure 70 and each define a channel, groove, or elongated opening extending along the exterior of the mounting structure 70. The second channels 88 extend generally parallel to the first channels 78 and to the wall 19. The second channels 88 are each bounded by the second mounting shoulder 82 on an above side and a third mounting shoulder 90 on an opposing below side. In particular, the second channels 88 each extend between the second mounting shoulder 82 and the third mounting shoulder 90.

The second channels 88 each include one or more projections disposed within the second channels 88. In one example, the second channels 88 each include a second projection 92. The second projection 92 is positioned within the second channels 88 and extends from the second mounting shoulder 82 to the third mounting shoulder 90. The second projection 92 defines an outcropping, protrusion, or the like within the second channels 88. In one example, the second projection 92 has a ramped shape. It is to be appreciated that only one of the second projections 92 is shown in FIG. 5, since the other second projection 92 is obstructed from view. However, it is understood that the second projections 92 can be substantially identical in structure and location in each of the second channels 88.

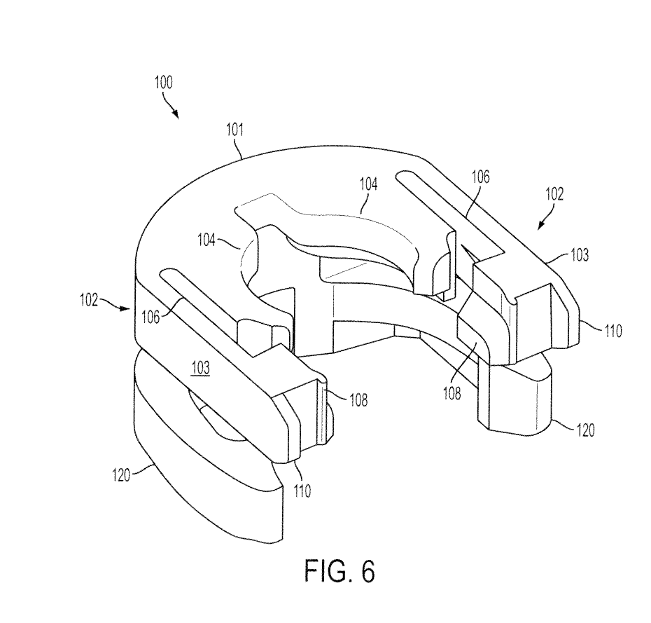

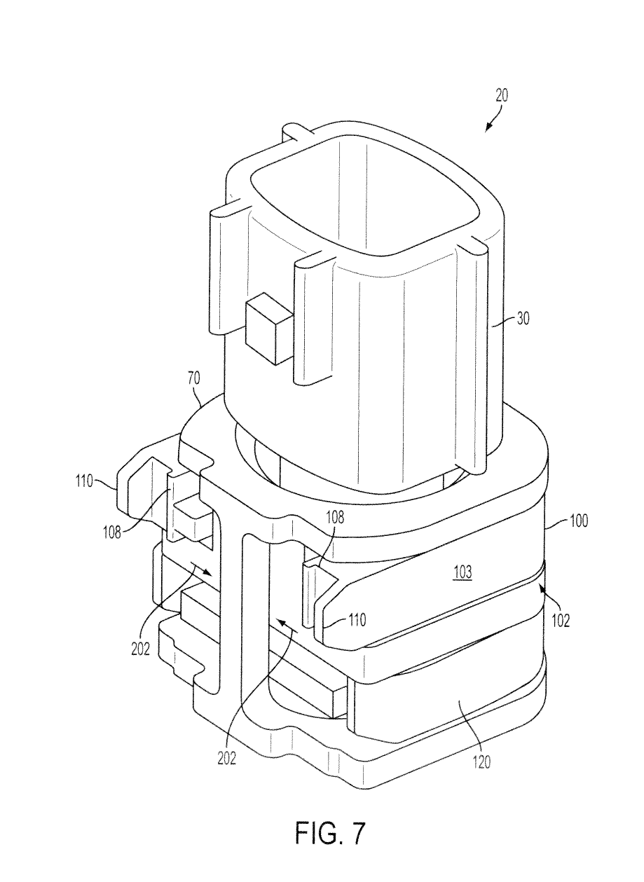

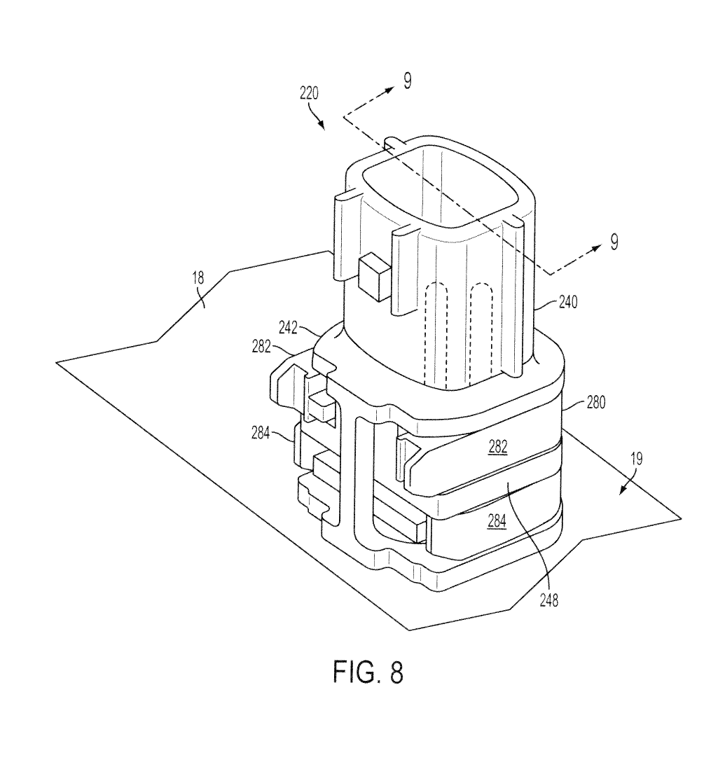

With continued reference to FIG. 5 and now with reference also to FIG. 6, the sensor assembly 20 further includes a retaining device 100. The retaining device 100 is sized and shaped to mate with the mounting structure 70. In particular, portions of the retaining device 100 are sized and shaped to fit within the first channels 78 and second channels 88, such that the retaining device 100 is relatively easily insertable and removable from the mounting structure 70.

The retaining device 100 includes a base portion 101. The base portion 101 extends along a length of the retaining device 100, such as a vertical length. The base portion 101 has a generally rounded shape, though in other examples, the base portion 101 may not be rounded. Instead, the base portion 101 could include edges or the like.

The retaining device 100 includes one or more attachment structures. In one example, the one or more attachment structures include a first pair of attachment structures 102. The first pair of attachment structures 102 each extends outwardly from the base portion 101. In particular, the first pair of attachment structures 102 extend from opposing ends of the base portion 101. In the shown example, the first pair of attachment structures 102 are substantially identical in size and shape, though in further examples, the first pair of attachment structures 102 can have different sizes and shapes.

The first pair of attachment structures 102 includes attachment arms 103. The attachment arms 103 are elongated, linearly extending members that extend from the base portion 101. The attachment arms 103 have a height that substantially matches the height of the first channels 78 (i.e., distance between first mounting shoulder 80 and second mounting shoulder 82). As such, the attachment arms 103 are sized and shaped to be insertable into the first channels 78.

The attachment arms 103 of the first pair of attachment structures 102 each include an engagement portion 104. The engagement portions 104 extend generally parallel to each other from the base portion 101. The engagement portions 104 each extend parallel to the attachment arms 103 at least partially along a length of the attachment arms 103. The engagement portions 104 are positioned between the attachment arms 103 and closer to a center of the retaining device 100 than the attachment arms 103. As such, a distance separating the engagement portions 104 is less than a distance separating the attachment arms 103. The engagement portion 104 can be substantially identical in size and shape, as shown. In one example, the engagement portions 104 each have a rounded inner surface that substantially matches a shape of the connector 30.

The attachment arms 103 and engagement portion 104 are spaced apart to form a slot 106. The slot 106 extends generally parallel to and between the attachment arms 103 and engagement portion 104. The slot 106 could be larger or smaller in further examples, and is not specifically limited to the size and shape shown herein. The slot 106 can allow for the first pair of attachment structures 102 to be elastically deformable. In particular, by providing the slot 106, the attachment arms 103 can move, such as by moving towards and away from the engagement portion 104 in response to a force acting upon the attachment arms 103. It is to be appreciated that the first pair of attachment structures 102 are not limited to including the slot 106 to provide for elastic deformation. In another example, the attachment arms 103 could be formed of a more pliable material, thus allowing for movement of the attachment arms 103.

The first pair of attachment structures 102 each include a gripping portion 108. In particular, each of the attachment arms 103 includes one of the gripping portions 108 disposed at an end of each of the attachment arms 103. The gripping portions 108 project in a direction that is substantially transverse to the direction along which the attachment arms 103 extend. As such, the gripping portions 108 project towards a center of the retaining device 100. The gripping portions 108 are substantially identical on each of the attachment arms 103. In operation, the gripping portions 108 can engage and grip the first projections 84 of the first channels 78. By engaging the first projections 84, the gripping portions 108 can limit the retaining device 100 from inadvertently disengaging from the mounting structure 70.

The first pair of attachment structures 102 further includes disengagement devices 110. In particular, each of the attachment arms 103 includes one of the disengagement devices 110. The disengagement device 110 can disengage the gripping portions 108 from the first projections 84 and allow for the retaining device 100 to be removed from the mounting structure 70. In one example, the disengagement devices 110 are disposed at ends of the attachment arms 103 opposite from the base portion 101. In the shown example, each of the disengagement devices 110 project from the gripping portions 108 in a direction that is substantially transverse to a direction of the gripping portions 108. A user can grip the disengagement devices 110 and push them outwardly (i.e., away from a center of the retaining device 100), such that the gripping portions 108 will disengage from the first projection 84. Once disengaged, the retaining device 100 can be removed from the mounting structure 70. It is to be appreciated that the disengagement devices 110 are not limited to the structure or location shown in the examples. Rather, in other examples, the disengagement devices 110 could be positioned at nearly any location along a length of the attachment arms 103, such as by defining a grippable outcropping, protrusion, or the like.

The one or more attachment structures of the retaining device 100 further include a second pair of attachment structures 120. The second pair of attachment structures 120 each extend outwardly from the base portion 101. In particular, the second pair of attachment structures 120 extend from opposing ends of the base portion 101. The second pair of attachment structures 120 can be substantially identical in size and shape, though in further examples, the second pair of attachment structures 120 can have different sizes and shapes from each other.

The second pair of attachment structures 120 are elongated, linearly extending members that extend from the base portion 101. In particular, the second pair of attachment structures 120 are disposed at an opposite end (e.g., lower end) of the base portion 101 from the first pair of attachment structures 102. The second pair of attachment structures 120 can extend generally parallel to the first pair of attachment structures 102. The second pair of attachment structures 120 have a height that substantially matches the height of the second channels 88 (i.e., distance between second mounting shoulder 82 and third mounting shoulder 90). As such, the second pair of attachment structures 120 are sized and shaped to be insertable into the second channels 88.

The second pair of attachment structures 120 can engage and grip a portion of the second channels 88. In particular, the second pair of attachment structures 120 will grip the second projection 92 when the second pair of attachment structures 120 are inserted into the second channels 88. The second pair of attachment structures 120 can include gripping structures, indentations, or the like for engaging the second projection 92. In further examples, friction between the second pair of attachment structures 120 and the second channels 88 (e.g., the second projection 92) can limit or reduce the likelihood of the retaining device 100 from inadvertently disengaging from the mounting structure 70.

Turning to FIGS. 4 to 7, the operation of the sensor assembly 20 will now be described. Referring first to FIG. 4, the connector 30 will initially be attached with respect to the enclosed volume 18. To attach the connector 30, the second end 34 of the connector will be inserted through the opening 74 and hollow bore 72 of the mounting structure 70, and then through the wall opening 61 of the wall 19. In particular, the sensing portion 60 will pass through the wall opening 61 such that the sensing element 62 is positioned within the enclosed volume 18. The connector 30 will be inserted until the seal retaining structure 54 contacts the wall 19 surrounding the wall opening 61.

Engagement between the seal retaining structure 54 and the wall 19 can drive the seal retaining structure 54 axially towards the seal 50. The seal 50 is limited from axial movement towards the first end 32 by contacting the third shoulder 52. The seal 50 will compress between the seal retaining structure 54 and the third shoulder 52. This compression of the seal 50 will cause the seal to engage both the connector 30 (e.g., the connector shaft 56, the third shoulder 52, etc.) and the mounting structure 70 (e.g., the hollow bore 72). As such, the seal 50 can contact and form a seal between the connector 30 and the mounting structure 70. The seal 50 can therefore reduce an unintended release of material (e.g., cooling fluid) from the enclosed volume 18.

Referring still to FIG. 4, as the connector 30 is positioned within the mounting structure 70, the retaining device 100 can engage and hold the connector 30 in place. In particular, the engagement portion 104 of the retaining device 100 contacts and engages the second shoulder 46 of the connector 30. The engagement portion 104 can be positioned between the first mounting shoulder 80 of the mounting structure 70 on one side and the second shoulder 46 on an opposing side. The engagement portion 104 therefore extends into the groove 42 and limits axial movement of the connector 30. For example, the connector 30 is limited from disengaging from the enclosed volume 18 and moving axially away from the wall 19 by contacting the engagement portion 104.

It is to be appreciated that the connector 30 will be fully engaged with the wall 19 before the engagement portion 104 can enter the groove 42. For example, when the connector shaft 56 is fully inserted into the wall opening 61 such that the seal 50 deforms, the connector 30 is fully engaged with the wall 19 and the engagement portion 104 can enter the groove 42. In this position (shown in FIG. 4), the second shoulder 46 is in alignment (i.e., radial alignment) with the first channel 78 and the engagement portion 104.

In another example, if the connector 30 is not fully engaged, such as by the connector shaft 56 not being fully inserted into the wall opening 61, then the engagement portion 104 may not be inserted into the groove 42. In such an example, the axial distance between the second shoulder 46 and the first mounting shoulder 80 will be smaller than a height of the engagement portion 104. As such, the connector 30 will have to be further inserted into the wall opening 61 before the engagement portion 104 will fit between the second shoulder 46 and the first mounting shoulder 80.

Turning now to FIG. 5, the retaining device 100 is shown in a partially engaged (e.g., not fully engaged) position with the mounting structure 70. In this example, the connector 30 is fully engaged with the enclosed volume 18 by the retaining device 100. In particular, the retaining device 100 will contact the connector 30 and the mounting structure 70 (as previously described) to limit the likelihood of the connector 30 from becoming inadvertently disengaged from the mounting structure 70. For example, after the connector 30 is inserted into the mounting structure 70, the retaining device 100 will engage the mounting structure 70. In particular, the first pair of attachment structures 102 are inserted into the first channels 78 while the second pair of attachment structures 120 are inserted into the second channels 88. As shown, the retaining device 100 will move in a first direction 200, such as by being pushed by a user.

As the retaining device 100 moves along the first direction 200, the first pair of attachment structures 102 and second pair of attachment structures 120 will move further into the first channel 78 and second channel 88. The gripping portions 108 of the attachment arms 103 will move over the first projections 84 by engaging (e.g., grip) the first projections 84. Likewise, the second pair of attachment structures 120 will likewise move over the second projections 92, by engaging (e.g., gripping) the second projections 92.

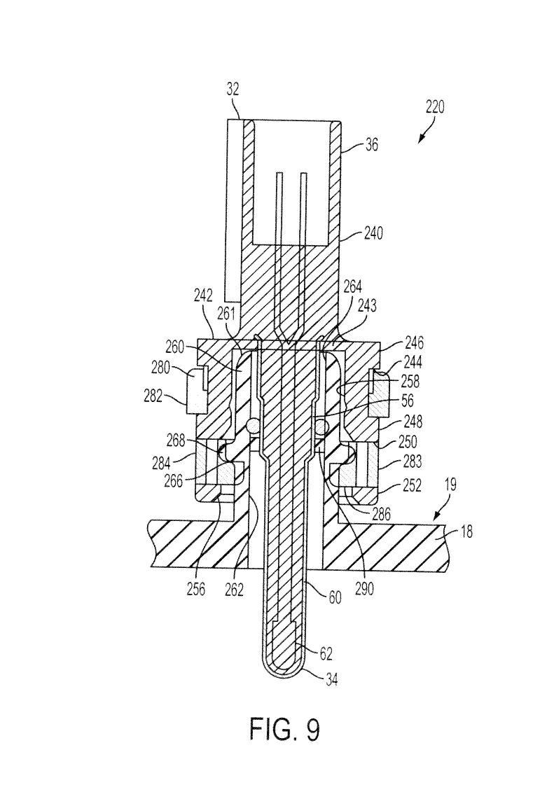

Turning now to FIG. 7, the retaining device 100 is shown in a fully engaged position with the mounting structure 70. In particular, once the attachment arms 103 pass over the first projections 84, the attachment arms 103 will move along a second direction 202. By moving in this second direction 202, the gripping portions 108 will be positioned in contact with the first projections 84. The gripping portions 108 will thus grip the first projections 84 and limit the retaining device 100 from disengaging from the mounting structure 70. Likewise, in this position, the second pair of attachment structures 120 will engage and grip the second projection 92, further limiting the retaining device 100 from disengaging from the mounting structure 70.

To remove the retaining device 100 from the mounting structure 70, a user will grip the disengagement devices 110 and move the disengagement devices 110 in a direction opposite the second direction 202. Moving the disengagement devices 110 in this direction will cause the gripping portions 108 to disengage from the first projections 84. The retaining device 100 can then be moved in a direction opposite from the first direction 200, thus disengaging the retaining device 100 from the mounting structure 70.

The retaining device 100 serves a number of functions. First, the retaining device 100 allows for relatively easy insertion and removal into the mounting structure 70. In the shown examples, a user can use a single hand or even one finger to push the retaining device 100 along the first direction 200. In addition, the retaining device 100 limits axial movement of the connector 30 and reduces the likelihood of the connector 30 from becoming disengaged from the enclosed volume 18. In such an example, the engagement portion 104 will engage the second shoulder 46 on one side and the first mounting shoulder 80 on an opposing side to limit the connector 30 from being removed. Likewise, the retaining device 100 may not engage the connector 30 and the mounting structure 70 until the connector is fully engaged with the wall 19 of the enclosed volume 18, as shown in FIG. 4.

The retaining device 100 is also unlikely from being inadvertently removed from the mounting structure 70 due to the engagement between the first pair of attachment structures 102 and first projections 84 and between the second pair of attachment structures 120 and the second projections 92. The retaining device 100 will remain in engagement with the mounting structure 70 as long as desired. Removal of the retaining device 100 from the mounting structure 70 is relatively easy, as the user can use one hand to move the disengagement devices 110 in a direction opposite the second direction 202.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A sensor assembly for sensing a condition within an enclosed volume, the sensor assembly including:
a mounting structure projecting from a wall bounding the enclosed volume, the mounting structure including an opening extending from an exterior of the mounting structure through the wall into the enclosed volume, the mounting structure including at least one channel extending along an exterior of the mounting structure;
a connector including a sensing portion that senses the condition within the enclosed volume, the connector being engagable with the mounting structure to extend the connector through the opening of the mounting structure and position the sensing portion at least partially within the enclosed volume;
a seal engagable with the mounting structure and sealing the enclosed volume at the extension of the connector through the opening; and
a retaining device including at least one attachment structure, the at least one attachment structure being insertable into the at least one channel to engage the connector and hold the connector engaged to the mounting structure extended through the opening.

2. The sensor assembly of claim 1, wherein the connector further includes at least one shoulder in alignment with the at least one channel when the connector is engaged with the mounting structure to extend the connector through the opening.

3. The sensor assembly of claim 2, wherein the at least one attachment structure of the retaining device is configured to engage the at least one shoulder of the connector.

4. The sensor assembly of claim 2, wherein the at least one attachment structure includes a first pair of attachment structures and a second pair of attachment structures.

5. The sensor assembly of claim 4, wherein the at least one channel includes first channels and second channels, the first pair of attachment structures are insertable into the first channels, the second pair of attachment structures are insertable into the second channels.

6. The sensor assembly of claim 5, wherein the first pair of attachment structures include an engagement portion that projects inwardly towards a center of the retaining device, the engagement portion contacting the at least one shoulder of the connector when the connector is engaged with the mounting structure to extend the connector through the opening and when the first pair of attachment structures are inserted into the first channels.

7. The sensor assembly of claim 5, wherein the first pair of attachment structures each includes a gripping portion disposed towards an end of each of the first pair of attachment structures, the gripping portion engaging the mounting structure to attach the retaining device to the mounting structure.

8. The sensor assembly of claim 7, wherein the first pair of attachment structures are elastically deformable such that when the first pair of attachment structures are elastically deformed, the retaining device is movable with respect to the mounting structure.

9. The sensor assembly of claim 1, wherein the seal extends circumferentially around a portion of the connector.

10. The sensor assembly of claim 9, wherein an inner portion of the seal contacts the connector and an outer portion of the seal contacts the mounting structure when the connector is engaged with the mounting structure to extend the connector through the opening.

11. An engine with a cooling system, the engine cooling system including:
an enclosed volume having cooling fluid therein, the cooling system including a wall bounding the enclosed volume; and
a sensor assembly for sensing a condition of the cooling fluid within the enclosed volume, the sensor assembly including:
a mounting structure projecting from the wall bounding the enclosed volume, the mounting structure including an opening extending from an exterior of the mounting structure through the wall into the enclosed volume, the mounting structure including at least one channel extending along an exterior of the mounting structure;
a connector including a sensing portion that senses the condition within the enclosed volume, the connector being engagable with the mounting structure to extend the connector through the opening of the mounting structure and position the sensing portion at least partially within the enclosed volume;
a seal engagable with the mounting structure and sealing the enclosed volume at the extension of the connector through the opening; and
a retaining device including at least one attachment structure, the at least one attachment structure being insertable into the at least one channel to engage the connector and hold the connector engaged to the mounting structure extended through the opening.

12. The engine of claim 11, wherein the connector further includes at least one shoulder in alignment with the at least one channel when the connector is engaged with the mounting structure to extend the connector through the opening.

13. The engine of claim 12, wherein the at least one attachment structure of the retaining device is configured to engage the at least one shoulder of the connector.

14. The engine of claim 12, wherein the at least one attachment structure includes a first pair of attachment structures and a second pair of attachment structures.

15. The engine of claim 14, wherein the first pair of attachment structures are insertable into first channels, the second pair of attachment structures being insertable into second channels.

16. The engine of claim 15, wherein the first pair of attachment structures include an engagement portion that projects inwardly towards a center of the retaining device, the engagement portion contacting the at least one shoulder of the connector when the connector is engaged with the mounting structure to extend the connector through the opening and when the first pair of attachment structures are inserted into the first channels.

17. The engine of claim 15, wherein the first pair of attachment structures each include a gripping portion disposed towards an end of each of the first pair of attachment structures, the gripping portion engaging the mounting structure to attach the retaining device to the mounting structure.

18. A method of providing a sensor assembly for sensing a condition within an enclosed volume, the method including the steps of:
providing a mounting structure projecting from a wall bounding the enclosed volume, the mounting structure including an opening extending from an exterior of the mounting structure through the wall into the enclosed volume, the mounting structure including at least one channel extending along an exterior of the mounting structure;
engaging a connector, which includes a sensing portion that senses the condition within the enclosed volume, to the mounting structure and extending the connector through the opening of the mounting structure and positioning the sensing portion at least partially within the enclosed volume;
engaging a seal with the mounting structure and sealing the enclosed volume at the extension of the connector through the opening; and
inserting at least one attachment structure of a retaining device into the at least one channel to engage the connector and hold the connector engaged to the mounting structure extended through the opening.

19. The method of claim 18, wherein the connector further includes at least one shoulder, the step of engaging the connector includes aligning the at least one shoulder with the at least one channel.

20. The method of claim 18, wherein the at least one attachment structure includes a first pair of attachment structures and a second pair of attachment structures and the at least one channel includes first channels and second channels, the step of inserting at least one attachment structure includes inserting the first pair of attachment structures into the first channels and inserting the second pair of attachment structures into the second channels.
